(19) United States
(12) Patent Application Publication
(10) Pub. No.: US 2008/0098440 A1
(43) Pub. Date: Apr. 24, 2008

(54) Method and system for transmitting broadcast data

(75) Inventors: Yuji Nagano, Fukuoka (JP); Kiyohide Yamashita, Fukuoka (JP)

Correspondence Address: BINGHAM MCCUTCHEN LLP, 2020 K Street, N.W., Intellectual Property Department, WASHINGTON, DC, 20006, US

(73) Assignee: FUJITSU LIMITED

(21) Appl. No.: 11/902,585

(22) Filed: Sep. 24, 2007

(30) Foreign Application Priority Data
Oct. 20, 2006 (JP) 2006-286853

(51) Int. Cl. H04N 7/24

(52) U.S. Cl. 725/75; 725/118

(57) ABSTRACT

An in-vehicle device receives broadcast data from a base station A, calculates a checksum of the received broadcast data, and transmits the checksum to a base station B. The base station B determines whether the checksum received from the in-vehicle device is correct. If the checksum is not correct, the base station B instructs a base station C to retransmit the broadcast data, and the base station C retransmits the broadcast data to the in-vehicle device.

### BACKGROUND OF THE INVENTION

1. Field of the Invention

The present invention relates to a technology for transmitting and retransmitting broadcast data in a road-to-vehicle communication system.

2. Description of the Related Art

Recently, a road-to-vehicle communication system of narrow-range communications using a dedicated short-range communication (DSRC) is widely commercialized. For example, an electronic toll collection system (ETC), which is now widely used, is one of services developed based on the technique of the DSRC. Furthermore, it is likely that the techniques of the DSRC are to be used more often for developing various services in the future.

In this road-to-vehicle communication system, a base station installed on a roadside transmits broadcast data to an in-vehicle device, without requiring a response on data reception from the in-vehicle device. Because the broadcast data does not require a response about whether the broadcast data has been correctly received, from a data receiving side, it is difficult for the base station to confirm whether the in-vehicle device has correctly received the data. Consequently, when a certain problem occurs in a radio area between the base station and the in-vehicle device, and if the broadcast data is not correctly transmitted to the in-vehicle device, a failure in the transmission of the broadcast data is hardly recovered.

To solve the above problems, Japanese Patent Application Laid-open No. 2005-117342 discloses a radio mobile communication system. In this radio mobile communication system, even when an in-vehicle device in a communicable area of a first base station leaves the communicable area and enters a communicable area of a second base station different from the first base station, the in-vehicle device can continuously receive the data from the first base station via the second base station. Accordingly, even when the first base station fails to correctly complete the data transmission to the in-vehicle device for some reason, the second base station relays the data transmission from the first base station. As a result, the possibility of correctly transmitting the data to the in-vehicle device can be improved.

Furthermore, Japanese Patent Application Laid-open No. 2000-358265 discloses a road-to-vehicle communication system. In this road-to-vehicle communication system, when an in-vehicle device in a communicable area of a first base station leaves the communicable area and enters a communicable area of a second base station different from the first base station, and when the same slot can be used for a communication with the first base station and the second base station, the in-vehicle device can smoothly and continuously receive the data transmission from the first base station via the second base station, by continuously using the same slot.

Moreover, Japanese Patent Application Laid-open No. 2004-364274 discloses a communication system that can adjust a data transmission speed from a base station to an in-vehicle device, depending on a moving speed of the in-vehicle device that moves within a communicable area of the base station, and a data size of transmission data from the base station to the in-vehicle device. Thus, it is possible to increase the possibility of completing data transmission before the in-vehicle device leaves the communicable area.

Furthermore, Japanese Patent Application Laid-open No. 2005-57326 discloses a road-to-vehicle data distribution system. In the road-to-vehicle data distribution system, an in-vehicle device that has received broadcast data from a base station determines whether the broadcast data has been received without a data drop after the broadcast data is received. When there is a data drop, the in-vehicle device can receive a retransmission of the dropped broadcast data from the same base station. The road-to-vehicle data distribution system can increase reliability of the transmission of broadcast data from the base station to the in-vehicle device.

However, according to the conventional techniques disclosed in the Japanese Patent Application Laid-open Nos. 2005-117342, 2000-358265, 2004-364274, and 2005-57326, when a communication error occurs in a radio section between the base station and the in-vehicle device, it has been difficult to correctly transmit the entire broadcast data to the in-vehicle device.

For example, according to the techniques disclosed in the Japanese Patent Application Laid-open Nos. 2005-117342 and 2000-358265, when the first base station cannot normally complete the data transmission to the in-vehicle device for some reason, the second base station relays the data transmission. However, even when the broadcast data is continuously transmitted from the second base station, this does not guarantee that the entire broadcast data is correctly transmitted to the in-vehicle device. When the broadcast data transmission is of broadcast type for communicating without identifying the in-vehicle device, it is difficult to trace the in-vehicle device when the in-vehicle device moves to the communicable area of the second base station. Consequently, the broadcast data is hardly transmitted continuously.

Furthermore, in the above conventional technique disclosed in the Japanese Patent Application Laid-open No. 2000-358265, when the whole slots of the transmission data from the second base station are used for data transmission when the in-vehicle device in the communicable area of the first base station leaves the communicable area of the first base station and enters the communicable area of the second base station different from the first base station, it is difficult to allocate a new slot for a communication with the second base station. Consequently, it is difficult for the in-vehicle device to receive the retransmission data of the broadcast data from the second base station.

Moreover, in the above conventional technique disclosed in the Japanese Patent Application Laid-open No. 2004-364274, it is possible to increase the possibility to complete the data transmission to the in-vehicle device while the in-vehicle device is in the communicable area. However, it is difficult to guarantee that the entire broadcast data is transmitted correctly to the in-vehicle device, like in the conventional technique disclosed in the Japanese Patent Application Laid-open No. 2005-117342.

In the conventional technique disclosed in the Japanese Patent Application Laid-open No. 2005-57326, because broadcast data is retransmitted when there is data drop in the received broadcast data, reliability of the broadcast data can be improved. However, when there is a data error in the received broadcast data, the data error cannot be detected. Therefore, it is difficult to guarantee that the entire broadcast data is correctly transmitted to the in-vehicle device. Because data slots are allocated to retransmit the broadcast data, decreasing the number of data slots that can be allocated to other broadcast data to be transmitted in parallel, data transmission efficiency of the broadcast data transmission is degraded.

Even when the conventional techniques disclosed in the Japanese Patent Application Laid-open Nos. 2005-117342, 2000-358265, 2004-364274, and 2005-57326 are combined together, it is difficult to detect a data drop and a data error of the broadcast data received by the in-vehicle device without decreasing the transmission efficiency of the broadcast data from the base station. Furthermore, it is difficult to efficiently retransmit the broadcast data when there is a data drop or a data error of the broadcast data received by the in-vehicle device.

### SUMMARY OF THE INVENTION

It is an object of the present invention to at least partially solve the problems in the conventional technology.

According to an aspect of the present invention, there is provided a method of transmitting broadcast data from a plurality of transmitting apparatus to a data receiving apparatus, each of the transmitting apparatuses having a transmission area in which broadcast data is transmitted from a corresponding one of the transmitting apparatuses, the transmitting apparatuses sharing the broadcast data, the receiving apparatus freely moving from one transmission area to another transmission area, the transmitting apparatuses including a first transmitting apparatus, a second transmitting apparatus, and a third transmitting apparatus, includes generating first verification data in the receiving apparatus based on the broadcast data received from the first transmitting apparatus; generating second verification data in the second transmitting apparatus based on the broadcast data; transmitting the first verification data from the receiving apparatus to the second transmitting apparatus when the receiving apparatus moves in a transmission area of the second data-transmitting apparatus; determining at the second transmitting apparatus whether the first verification data is valid based on the second verification data; transmitting a retransmission instruction of the broadcast data from the second transmitting apparatus to the third transmitting apparatus when the first verification data is determined as not valid; and retransmitting the broadcast data based on the retransmission instruction from the third transmitting apparatus to the receiving apparatus

According to another aspect of the present invention, there is provided a receiving apparatus that receives broadcast data transmitted from a plurality of transmitting apparatuses in each transmission area of the transmitting apparatuses, the transmitting apparatuses including a first transmitting apparatus, a second transmitting apparatus, and a third transmitting apparatus, the receiving apparatus freely moving from one transmission area to another transmission area, includes a generating unit that generates verification data based on the broadcast data received from the first transmitting apparatus; and a transmitting unit that transmits the verification data to the second transmitting apparatus when the receiving apparatus moves in a transmission area of the second transmitting apparatus.

According to still another aspect of the present invention, there is provided a transmitting apparatus that transmits broadcast data to a receiving apparatus, and receives verification data generated based on the broadcast data from the receiving apparatus when the receiving apparatus is in a transmission area of the transmitting apparatus, includes a determining unit that determines whether the verification data received from the receiving apparatus is valid; a transmitting unit that transmits a retransmission instruction of the broadcast data, to another transmitting apparatus when the determining unit determines that the verification data is not valid; a receiving unit that receives a retransmission instruction from another transmitting apparatus; and a retransmitting unit that retransmits the broadcast data to the receiving apparatus upon the receiving unit receiving the retransmission instruction.

According to still another aspect of the present invention, there is provided a data transmission system including the above receiving apparatus and the above transmitting apparatus.

The above and other objects, features, advantages and technical and industrial significance of this invention will be better understood by reading the following detailed description of presently preferred embodiments of the invention, when considered in connection with the accompanying drawings

### BRIEF DESCRIPTION OF THE DRAWINGS

FIG. 1 is a schematic diagram for explaining characteristics of the present invention;

FIG. 2 is a schematic diagram of a road-to-vehicle communication system according to a first embodiment of the present invention;

FIG. 3 is a table of an example of a communication frame format of broadcast data transmitted from a base station shown in FIG. 2;

FIG. 4 is a table of an example of a checksum-notification command format transmitted to the base station shown in FIG. 2;

FIG. 5 is a functional block diagram of a base station shown in FIG. 2;

FIG. 6 is a functional block diagram of an in-vehicle device shown in FIG. 2;

FIG. 7 is a time chart of a broadcast data retransmission process according to the first embodiment;

FIG. 8 is a table of an example of a communication frame format of broadcast data having priority information according to a second embodiment of the present invention;

FIG. 9 is a time chart of a broadcast data retransmission process according to the second embodiment;

FIG. 10 is a table of another example of the communication frame format shown in FIG. 8;

FIG. 11 is a table of an example of a communication-channel notification command format according to a third embodiment of the present invention;

FIG. 12 is a time chart of a broadcast data retransmission process according to the third embodiment;

FIG. 13 is flowchart of a communication-channel selection notification process according to the third embodiment;

FIG. 14 is a schematic diagram for explaining an operation performed when checksums are same with each other according to the third embodiment;

FIG. 15 is a schematic diagram for explaining an operation performed when checksums are different from each other according to the third embodiment;

FIG. 16 is a functional block diagram of a base station according to a fourth embodiment of the present invention; and

FIG. 17 is a time chart of a broadcast data retransmission process according to the fourth embodiment.

### DETAILED DESCRIPTION OF THE PREFERRED EMBODIMENTS

Exemplary embodiments of the present invention are explained in detail below with reference to the accompanying drawings. The application of the present invention to a road-to-vehicle communication system of narrow-range communications using a DSRC is explained in first to fourth embodiments of the present invention. In this case, base stations serve as data transmitting apparatuses, which are placed at intervals of 20 meters to 30 meters along a road, each base station having a transmission-data accessible area with a radius of 10 meters to 15 meters. An in-vehicle device mounted on a vehicle that passes at the speed of about 140 km/h in the transmission-data accessible area of the base stations serves as a data receiving apparatus. Application of the present invention is not limited to the road-to-vehicle communication system. The invention can be widely applied to a data communication system that includes a data transmitting apparatus and a data receiving apparatus capable of communicating with each other as specified communication parties, and that can transmit broadcast data without specifying a communication party for radio communication with data receiving apparatuses present in the transmission-data accessible area of the data transmitting apparatus.

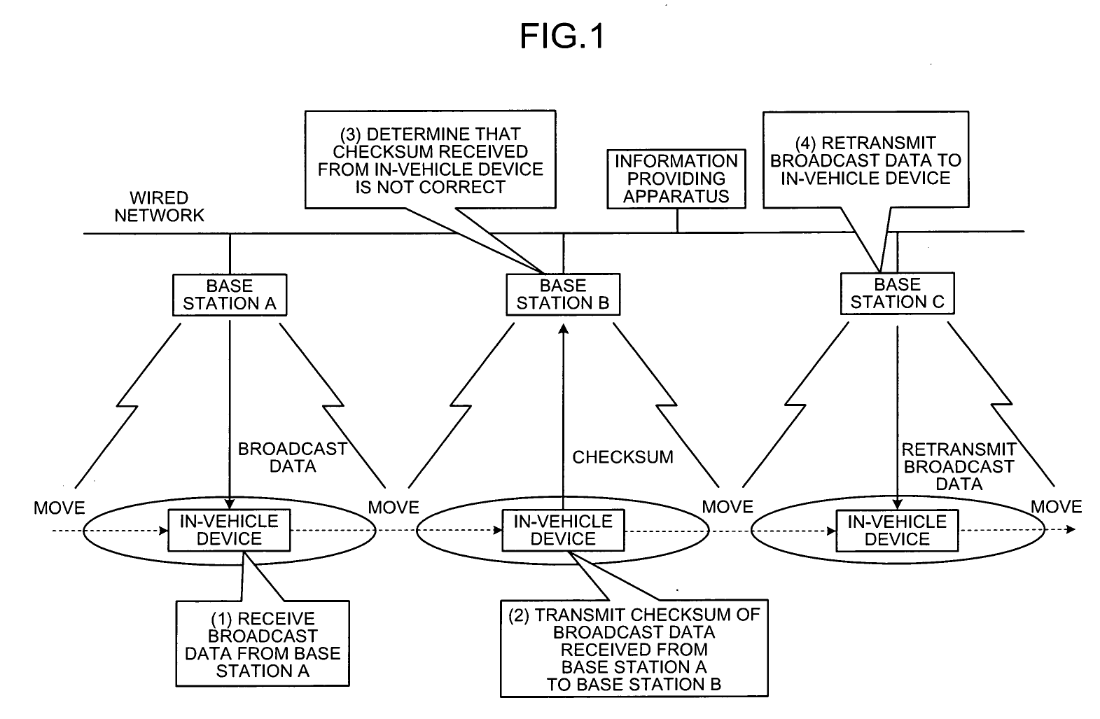

Characteristics of the present invention are explained before explaining the first to the fourth embodiments with reference to FIG. 1. As shown in FIG. 1, an information providing apparatus, a base station A, a base station B, and a base station C are connected to a wired network. An in-vehicle device moves in a transmission-data accessible area of the base stations A to C. The information providing apparatus is a server that stores therein broadcast data transmitted to the in-vehicle device via the base stations A to C. The broadcast data is identifiably transmitted in advance from the server to each base station via the wired network.

The base stations A to C are placed in this order along the same road. The transmission-data accessible area of each base station is adjacent to each other. When the in-vehicle device leaves the transmission-data accessible area of the base station A, the in-vehicle device immediately enters the transmission-data accessible area of the base station B. When the in-vehicle device leaves the transmission-data accessible area of the base station B, the in-vehicle device immediately enters the transmission-data accessible area of the base station C.

In the road-to-vehicle communication system, the base station A first transmits broadcast data to the in-vehicle device. The base station B receives a checksum as verification data based on the broadcast data from the in-vehicle device. The base station C retransmits the broadcast data to the in-vehicle device, when the base station B determines that the checksum is not valid as a result of testing the validity of the checksum. Particularly, it is assumed that the information providing apparatus transmits in advance the same broadcast data to the base stations A and C.

The outline of the process carried out in the present invention is explained below with reference to FIG. 1. The in-vehicle device receives broadcast data from the base station A. The in-vehicle device leaves the transmission-data accessible area of the base station A, and enters the transmission-data accessible area of the base station B. Subsequently, the in-vehicle device calculates a checksum of the broadcast data received from the base station A, and transmits the checksum to the base station B.

The base station B verifies the checksum and determines that the checksum received from the in-vehicle device is not correct. After determining that the checksum is not correct, the base station B instructs the base station C to retransmit the broadcast data. During this period, the in-vehicle device leaves the transmission-data accessible area of the base station B, and enters the transmission-data accessible area of the base station C. The base station C retransmits the broadcast data to the in-vehicle device.

As explained above, the base station A first transmits the broadcast data to the in-vehicle device. The base station B receives a checksum from the in-vehicle device, and determines about the validity of the checksum. The base station C retransmits the broadcast data to the in-vehicle device. With this arrangement, it becomes possible to securely transmit correct broadcast data, in the broadcast-data transmission in which the data is transmitted in only one direction in principle and the transmitter cannot confirm data reception of the receiver.

In the first to the fourth embodiments, the base station A transmits broadcast data to the in-vehicle device, and the base station B receives a checksum of the verification data based on the broadcast data from the in-vehicle device, and determines about the validity of the checksum. The base station C retransmits the broadcast data to the in-vehicle device, when the base station B determines that the checksum is not valid as a result of testing the validity of the checksum. Although operations described above are separately performed by each of the base stations, all functions can be achieved by one base station.

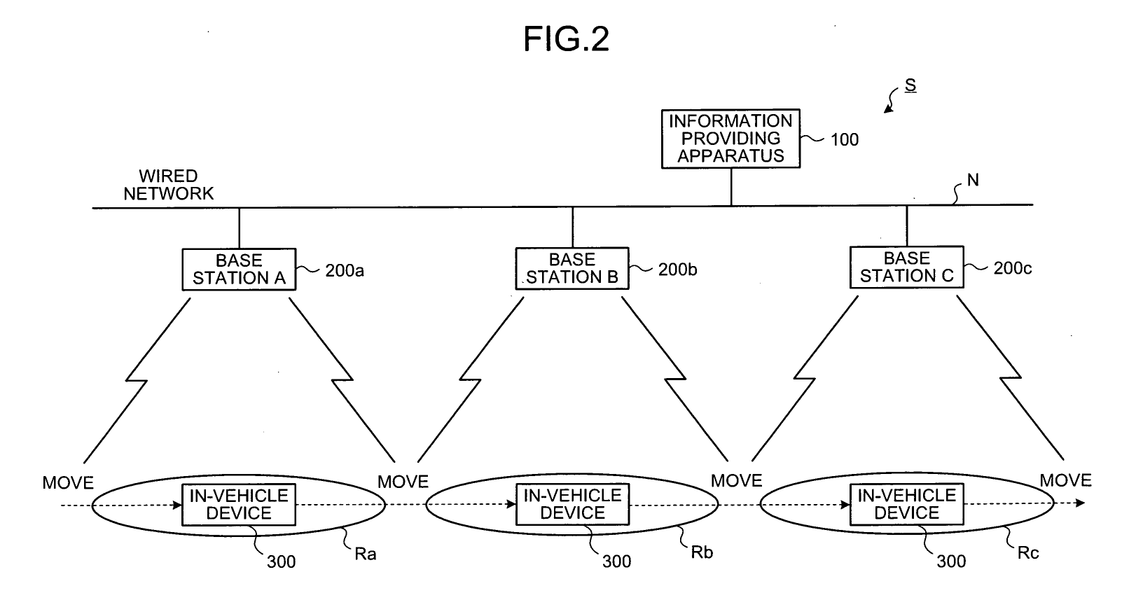

The first embodiment is explained below with reference to FIG. 2 to FIG. 7. A configuration of the system according to the first embodiment is explained with reference to FIG. 2. As shown in FIG. 2, a road-to-vehicle communication system S according to the first embodiment includes an information providing apparatus 100, a base station A 200a, a base station B 200b, and a base station C 200c, which are connected to a wired network N.

The information providing apparatus 100 is a server apparatus that stores broadcast data. The information providing apparatus 100 transmits in advance the same broadcast data to the base station A 200a, the base station B 200b, and the base station C 200c. Each of the base stations identifiably stores therein the received broadcast data. Particularly, in the first embodiment, the same broadcast data is transmitted in advance to the base station A 200a, the base station B 200b, and the base station C 200c.

When an in-vehicle device 300 is in a transmission-data accessible area Ra of the base station A 200a, the in-vehicle device 300 can radio communicate with the base station A 200a. Particularly, in the first embodiment, the in-vehicle device 300 can receive broadcast data from the base station A 200a. When the in-vehicle device 300 is in a transmission-data accessible area Rb of the base station B 200b, the in-vehicle device 300 can radio communicate with the base station B 200b. Particularly, in the first embodiment, the in-vehicle device 300 can transmit a checksum based on the broadcast data, to the base station B 200b. When the in-vehicle device 300 is in a transmission-data accessible area Rc of the base station C 200c, the in-vehicle device 300 can radio communicate with the base station C 200c. Particularly, in the first embodiment, the in-vehicle device 300 can receive the broadcast data, which is the same as the broadcast data transmitted from the base station A 200a, and retransmitted from the base station C 200c.

The in-vehicle device 300 moves from the transmission-data accessible area Ra to the transmission-data accessible area Rb, and to the transmission-data accessible area Rc. The base station B 200b receives a checksum from the in-vehicle device 300 in the transmission-data accessible area Rb, and determines about the validity of the checksum. When it is determined that the checksum is not valid, the base station B 200b instructs the base station C 200c to retransmit, to the in-vehicle device 300, the broadcast data which is the same as the broadcast data transmitted from the base station A 200a to the in-vehicle device 300. Based on the retransmission instruction, the base station C 200c retransmits the broadcast data to the in-vehicle device 300 by specifying the in-vehicle device 300.

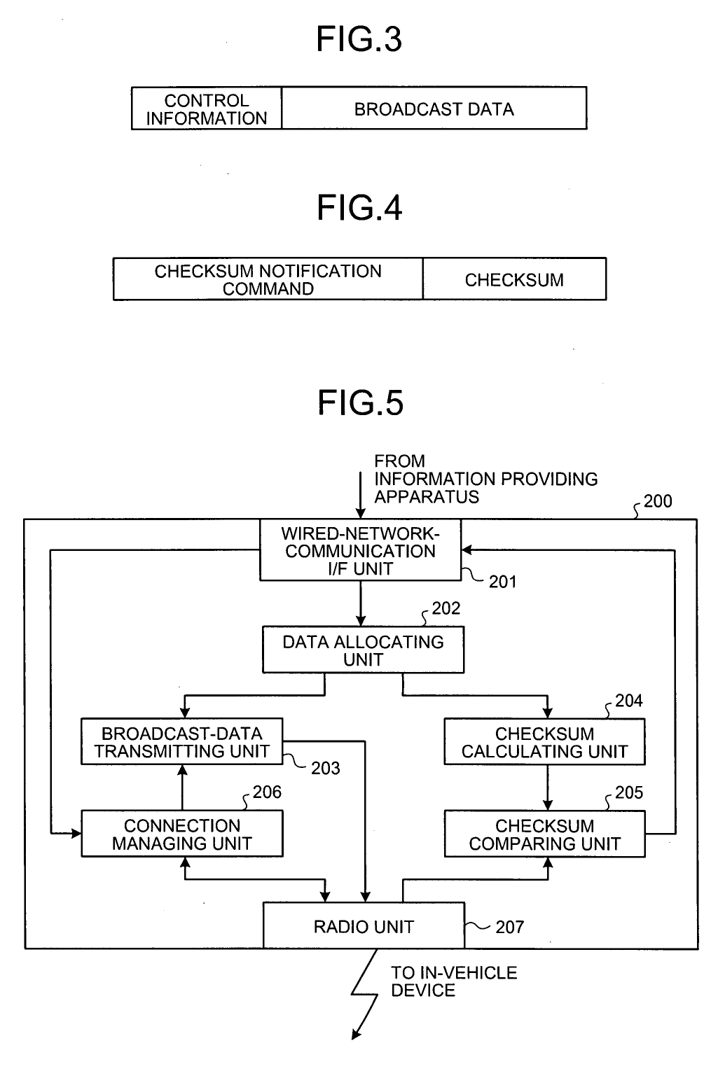

An explanation is made about a communication frame format of the broadcast data transmitted from the information providing apparatus 100 to the base station A 200a, the base station B 200b, and the base station C 200c, or transmitted from the base station A 200a, the base station B 200b, and the base station C 200c to the in-vehicle device 300, in the road-to-vehicle communication system S shown in FIG. 2. FIG. 3 is a table of an example of a communication frame format of the broadcast data.

As shown in FIG. 3, the communication frame format of the broadcast data contains control information as header information and broadcast data as payload. When the broadcast data is transmitted from the information providing apparatus 100 to the base station A 200a, the base station B 200b, and the base station C 200c via the wired network, the control information is an Internet Protocol (IP) header, and the payload is the broadcast data itself. When broadcast data is transmitted from the base station A 200a, the base station B 200b, and the base station C 200c to the in-vehicle device 300, the control information is a frame control message slot (FCMS), and the broadcast data contains plural message data slots (MDS). When the in-vehicle device 300 requests a communication connection to the base station A 200a, the base station B 200b, and the base station C 200c, a part of the MDS is used as an activation slot (ACTS).

The format of the checksum notification command transmitted from the in-vehicle device 300 to the base station A 200a, the base station B 200b, and the base station C 200c in the road-to-vehicle communication system S shown in FIG. 2 is explained below. FIG. 4 is a table of an example of a checksum-notification command format.

As shown in FIG. 4, the checksum-notification command format contains a checksum notification command and a checksum. The checksum notification command can be stored in the FCMS. It can be arranged in such a manner that the checksum is stored in the MDS, and a part of the MDS is used as the ACTS.

A configuration of the base station in the road-to-vehicle communication system S according to the first embodiment is explained below. FIG. 5 is a functional block diagram of a base station 200 (collective description of the base station A 200a, the base station B 200b, and the base station C 200c). As shown in FIG. 5, the base station 200 includes a wired-network-communication interface (I/F) unit 201, a data allocating unit 202, a broadcast-data transmitting unit 203, a checksum calculating unit 204, a checksum comparing unit 205, a connection managing unit 206, and a radio unit 207.

The wired-network-communication I/F unit 201 is the interface that communicates between the information providing apparatus 100 and the other base station 200 via the wired network N. The base station 200 receives broadcast data from the information providing apparatus 100 via the wired-network-communication I/F unit 201, and transmits a retransmission instruction of the broadcast data specifying the in-vehicle device 300 to the other base station 200, or receives a retransmission instruction of the broadcast data specifying the in-vehicle device 300 from the other base station 200.

The data allocating unit 202 allocates the broadcast data received via the wired-network-communication I/F unit 201, to the broadcast-data transmitting unit 203 or to the checksum calculating unit 204. The data allocating unit 202 transfers the broadcast data received from the information providing apparatus 100 to the broadcast-data transmitting unit 203 to transmit the broadcast data to the in-vehicle device 300, and transfers the broadcast data to the checksum calculating unit 204 to calculate the checksum.

The broadcast-data transmitting unit 203 identifiably stores therein the broadcast data transferred from the data allocating unit 202, and transfers the broadcast data to the radio unit 207 to transmit the stored broadcast data to the in-vehicle device 300. The checksum calculating unit 204 calculates a total value of the broadcast data transferred from the data allocating unit 202. In calculating the checksum, the checksum calculating unit 204 can calculate a total value of all frames of the broadcast data or a total value in each block unit that constitutes the frame of the broadcast data.

The checksum comparing unit 205 compares the checksum of the broadcast data calculated by the checksum calculating unit 204 with the checksum of the broadcast data received from the in-vehicle device 300 via the radio unit 207. As a result of the comparison, when the checksums of the broadcast data do not coincide with each other, the checksum comparing unit 205 specifies the identification information of the in-vehicle device 300 of which checksum does not coincide, and the broadcast data of which checksum does not coincide. Thereafter, the checksum comparing unit 205 instructs the wired-network-communication I/F unit 201 via the wired network N to retransmit the broadcast data to the other base station 200 of which transmission-data accessible area is adjacent to the one of the original base station 200 in the moving direction of the in-vehicle device 300.

The connection managing unit 206 manages one-to-one communication carried out between the base station 200 and the in-vehicle device 300. Specifically, the connection managing unit 206 manages the connection management information, such as identification information of the in-vehicle device 300, and a communication state, such as a communication start and a communication start time, that are necessary to carry out the one-to-one communication. With this arrangement, the base station 200 and the in-vehicle device 300 can communicate with each other by identifying each other. The connection managing unit 206 outputs the retransmission instruction to the broadcast-data transmitting unit 203 to transmit the broadcast data retransmission instruction to the assigned in-vehicle device 300, based on the broadcast data retransmission instruction from the other base station 200 received via the wired-network-communication I/F unit 201.

The radio unit 207 is an interface that carries out radio communications with the in-vehicle device 300. The radio unit 207 transmits broadcast data transferred from the broadcast-data transmitting unit 203 to the in-vehicle device 300. The radio unit 207 transmits and receives the connection management information of the one-to-one communication identifying each other between the connection managing unit 206 and the in-vehicle device 300, in between the connection managing unit 206 and the in-vehicle device 300. The radio unit 207 also transfers the checksum of the broadcast data transmitted from the in-vehicle device 300, to the checksum comparing unit 205.

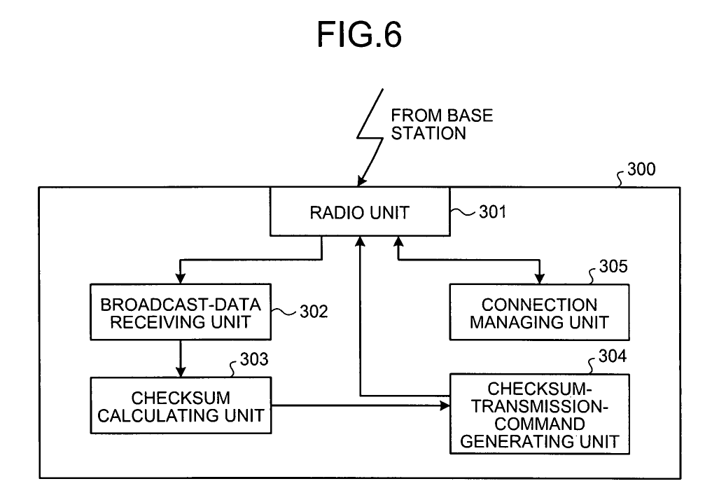

A configuration of the in-vehicle device in the road-to-vehicle communication system S according to the first embodiment is explained below. FIG. 6 is a functional block diagram of the in-vehicle device 300. As shown in FIG. 6, the in-vehicle device 300 includes a radio unit 301, a broadcast-data receiving unit 302, a checksum calculating unit 303, a checksum-transmission-command generating unit 304, and a connection managing unit 305.

The radio unit 301 is an interface that carries out radio communications with the base station 200. The radio unit 301 transmits a checksum transmission command transferred from the checksum-transmission-command generating unit 304 to the base station 200. The radio unit 301 transmits and receives the connection management information of the one-to-one communication between the connection managing unit 305 and the base station 200, in between the connection managing unit 305 and the base station 200. The radio unit 301 also transfers the broadcast data transmitted from the base station 200, to the broadcast-data receiving unit 302.

The broadcast-data receiving unit 302 transfers the broadcast data transferred from the radio unit 301 to the checksum calculating unit 303 to calculate the checksum. The checksum calculating unit 303 calculates a total value of the broadcast data transferred from the broadcast-data receiving unit 302. In calculating the checksum, the checksum calculating unit 303 can calculate a total value of the whole frames of the broadcast data or calculate a total value in each block unit that constitutes the frame of the broadcast data.

The checksum-transmission-command generating unit 304 transmits the checksum transferred from the checksum calculating unit 303, to the base station 200 via the radio unit 301, by specifying the broadcast data to be used as the basis of the checksum. In this case, the base station 200 to which the checksum is transmitted is specified based on the connection management information managed by the connection managing unit 305.

The connection managing unit 305 manages the one-to-one communication between the base station 200 and the in-vehicle device 300. Specifically, the connection managing unit 305 manages the connection management information, such as identification information of the base station 200 and a communication state (e.g., state of a communication start and a communication start time), that are necessary to carry out the one-to-one communication. With this arrangement, the base station 200 and the in-vehicle device 300 can communicate with each other.

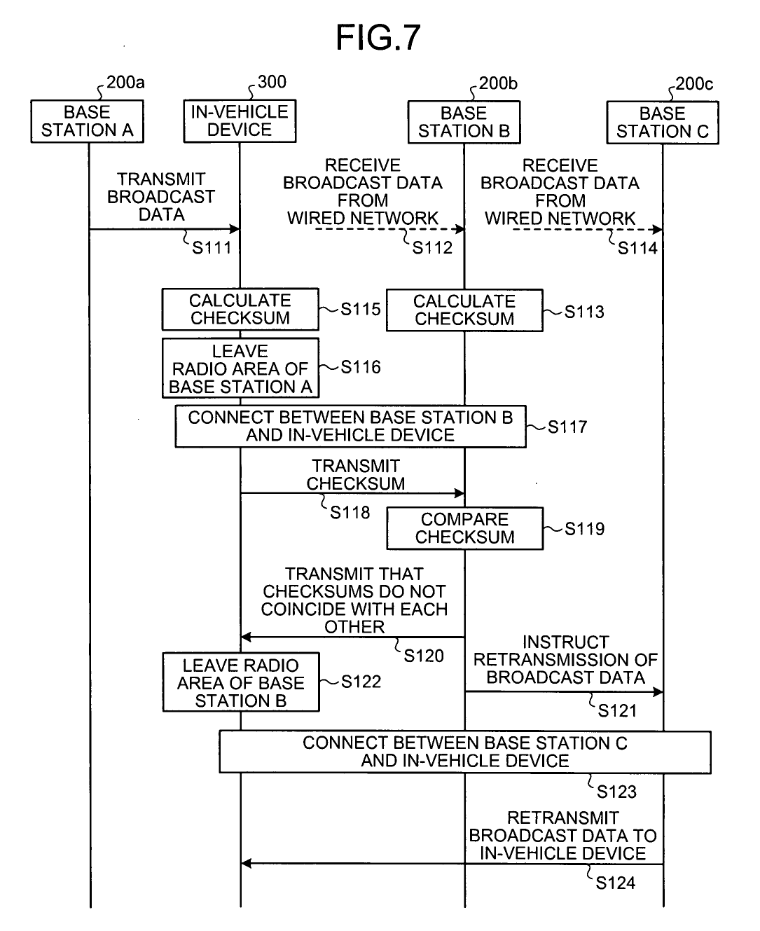

The broadcast data retransmission process to be executed by the road-to-vehicle communication system S in the first embodiment shown is explained below. FIG. 7 is a time chart of the broadcast data retransmission process executed by the road-to-vehicle communication system S in the first embodiment. In the process executed in connection with FIG. 7, it is assumed that the information providing apparatus 100 transmits broadcast data to the base station A 200a, the base station B 200b, and the base station C 200c, via the wired network N. The broadcast data transmitted to the base station A 200a is the data to be transmitted as the broadcast data. The broadcast data transmitted to the base station B 200b is used to calculate in advance the checksum for comparison. The broadcast data transmitted to the base station C 200c is the broadcast data for retransmission.

As shown in FIG. 7, the base station A 200a transmits broadcast data to the in-vehicle device 300 (step S111). The base station B 200b receives the broadcast data via the wired network N (step S112), and calculates in advance a checksum based on the received broadcast data (step S113). The base station C 200c receives the broadcast data (step S114).

The in-vehicle device 300 calculates a checksum based on the broadcast data received at step S111 from the base station A 200a (step S115). The in-vehicle device 300 leaves the radio area (a transmission-data accessible area) of the base station A 200a. (step S116), and enters the radio area of the base station B 200b. The in-vehicle device 300 performs a connection process for wirelessly connecting itself to the base station B 200b (step S117). The connection process is for establishing a one-to-one communication between the base station 200 and the in-vehicle device 300.

The in-vehicle device 300 transmits a checksum to the base station B 200b (step S118). The base station B 200b receives the checksum, and compares the checksum with the checksum calculated in advance by the base station B 200b (step S119). When both checksums coincide with each other, the subsequent process is omitted. On the other hand, when the two checksums do not coincide with each other, the base station B 200b notifies the in-vehicle device 300 that the checksums do not coincide with each other (step S120). In this case, the base station B 200b notifies a communication channel to be used to receive the retransmission of the broadcast data from the base station C 200c, to the in-vehicle device 300. When the in-vehicle device 300 receives the notification of the communication channel to be used to receive the retransmission of the broadcast data from the base station C 200c, the in-vehicle device 300 does not need to carry out a channel scan of the communication channel (a search process of the communication channel) in the transmission-data accessible area of the base station C 200c, and can promptly receive the retransmission of the broadcast data. The base station B 200b instructs the base station C 200c to retransmit the broadcast data (step S121).

The in-vehicle device 300 leaves the radio area (a transmission-data accessible area) of the base station B 200b (step S122), and enters the radio area of the base station C 200c. The in-vehicle device 300 wirelessly connects itself to the base station C 200c (step S123). The base station C 200c retransmits the broadcast data to the in-vehicle device 300 (step S124).

As explained above, according to the first embodiment of the present invention, when the in-vehicle device 300 cannot correctly receive the broadcast data transmitted from the base station 200, the broadcast data is retransmitted again exclusively to the in-vehicle device 300 that cannot correctly receive the broadcast data. By efficiently using the transmission path between the base station 200 and the in-vehicle device 300, the in-vehicle device 300 can securely receive the broadcast data.

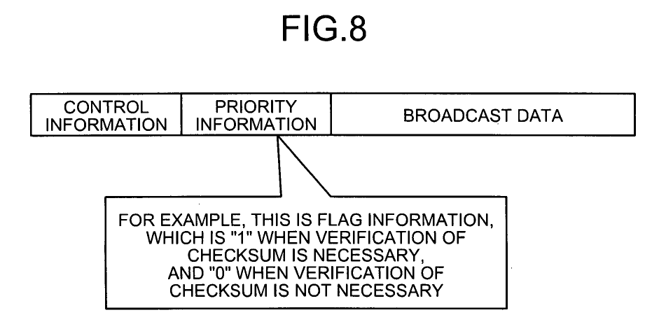

The second embodiment according to the present invention is explained below with reference to FIGS. 8 to 10. In the second embodiment, information of priority, indicative of whether determination of validity of verification data is to be performed, is added to the frame format (see FIG. 3) of the broadcast data explained in the first embodiment. The configuration of the road-to-vehicle communication system S, and the configurations of the information providing apparatus 100, the base station 200, and the in-vehicle device 300 respectively in the second embodiment are the same as those explained in the first embodiment, and therefore their explanations will be omitted. Similarly, constituent elements in the second embodiment identical with those of the first embodiment are not explained, and only different points are explained.

An explanation is made about a communication frame format of the broadcast data transmitted from the information providing apparatus 100 to the base station A 200a, the base station B 200b, and the base station C 200c, or transmitted from the base station A 200a, the base station B 200b, and the base station C 200c to the in-vehicle device 300, in the road-to-vehicle communication system S in the second embodiment. FIG. 8 is a table of an example of a communication frame format of the broadcast data having priority information.

As shown in FIG. 8, the communication frame format of the broadcast data having priority information according to the second embodiment contains the priority information inserted into between the control information and the broadcast data. The priority information is stored into the MDS. This priority information is, for example, flag information. When the calculation of a checksum by the in-vehicle device 300 and the verification of a checksum in the base station B 200b are necessary, “1” is set, and when the verification of the checksum is not necessary, “0” is set, as flag information.

This priority information is determined and set by the input operation based on an artificial determination or by the automatic determination process carried out by the information providing apparatus 100, before the information providing apparatus 100 transmits the broadcast data to the base station 200 via the wired network N. The information providing apparatus 100 transmits the broadcast data set with the priority information to the base station A 200a, the base station B 200b, and the base station C 200c, via the wired network N, as explained above. When the priority information is “1”, the base station B 200b calculates the total value of the broadcast data and calculates the checksum in advance. When the priority information is “0”, the base station B 200b does not calculate the total value of the broadcast data and does not calculate the checksum.

When the priority information is “0”, the information providing apparatus 100 can be controlled to transmit the broadcast data to only the base station A 200a. With the above arrangement, the base station B 200b and the base station C 200c, which do not require the broadcast data, do not receive unnecessary data. As a result, processing load can be decreased, and the traffic of the wired network N can be decreased because unnecessary data is not transmitted or received.

When the priority information is “1”, verification of the checksum is necessary. Therefore, the in-vehicle device 300 that has received the broadcast data calculates the checksum based on the broadcast data, and transmits the calculated checksum to the base station B 200b. The base station B 200b receives the checksum from the in-vehicle device 300, and compares the checksum received from the in-vehicle device 300 with the checksum calculated in advance. As a result of the comparison, when the checksums do not coincide with each other, the base station B 200b instructs the base station C 200c to retransmit the broadcast data to the in-vehicle device 300.

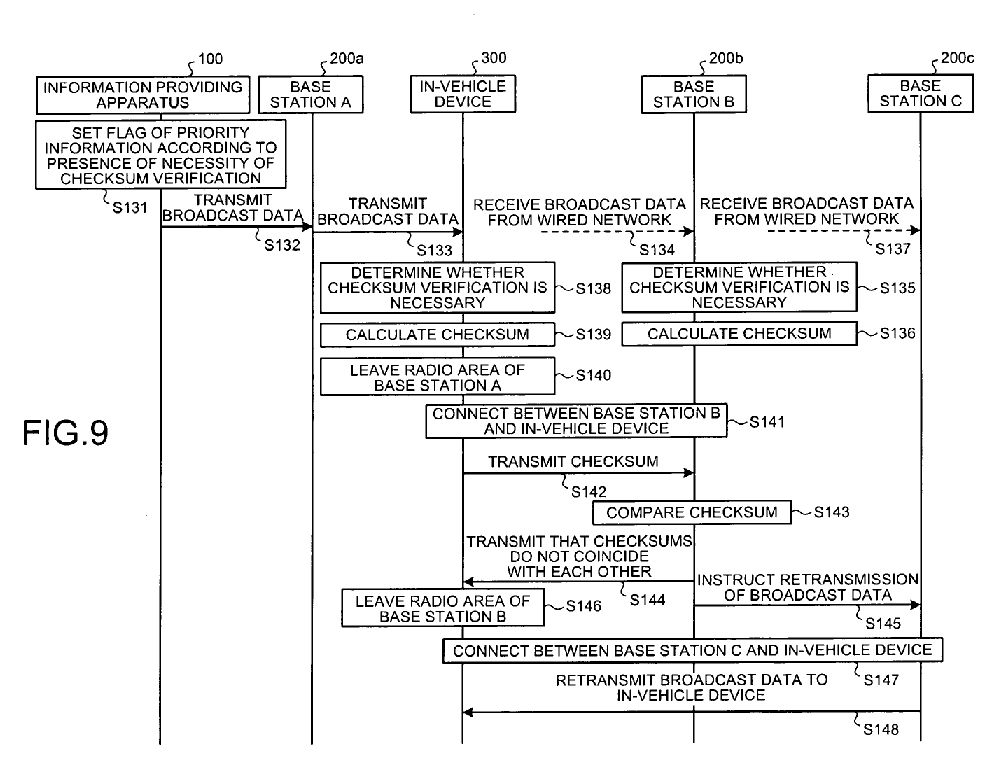

The broadcast data retransmission process executed in the road-to-vehicle system S in the second embodiment is explained below. FIG. 9 is a time chart of the broadcast data retransmission process executed in the road-to-vehicle system S in the second embodiment. In the process executed in connection with FIG. 9, it is assumed that the information providing apparatus 100 sets in advance the priority information of the broadcast data, and the information providing apparatus 100 transmits broadcast data to the base station A 200a, the base station B 200b, and the base station C 200c, via the wired network N.

First, the information providing apparatus 100 sets the flag of priority information, based on presence or absence of necessity of the checksum verification (step S131). The information providing apparatus 100 transmits broadcast data to the base station A 200a (step S132). The base station A 200a transmits the broadcast data to the in-vehicle device (step S133).

The information providing apparatus 100 transmits the broadcast data to the base station B 200b (step S134). The base station B 200b receives the broadcast data, and determines whether the checksum verification of the broadcast is necessary (step S135). When it is determined at step S135 that the checksum verification is necessary, the base station B 200b calculates the checksum, based on the broadcast data received at step S134 from the base station A 200a (step S136). The information providing apparatus 100 transmits the broadcast data to the base station C 200c (step S137).

The in-vehicle device 300 receives the broadcast data, and determines whether the checksum verification is necessary (step S138). The in-vehicle device 300 calculates the checksum, based on the broadcast data received at step S133 from the base station A 200a (step S139). The in-vehicle device 300 leaves the radio area (a transmission-data accessible area) of the base station A 200a (step S140), and enters the radio area of the base station B 200b. The in-vehicle device 300 wirelessly connects itself to the base station B 200b (step S141).

The in-vehicle device 300 transmits a checksum to the base station B 200b (step S142). The base station B 200b receives the checksum, and compares the checksum with the checksum calculated in advance by the base station B 200b (step S143). When both checksums coincide with each other, the subsequent process is omitted. On the other hand, when the two checksums do not coincide with each other, the base station B 200b notifies the in-vehicle device 300 that the checksums do not coincide with each other (step S144). In this case, the base station B 200b notifies a communication channel to be used to receive the retransmission of broadcast data from the base station C 200c, to the in-vehicle device 300. The base station B 200b instructs the base station C 200c to retransmit the broadcast data (step S145).

The in-vehicle device 300 leaves the radio area (a transmission-data accessible area) of the base station B 200b (step S146), and enters the radio area of the base station C 200c. The in-vehicle device 300 wirelessly connects itself to the base station C 200c (step S147). The base station C 200c retransmits the broadcast data to the in-vehicle device 300 (step S148).

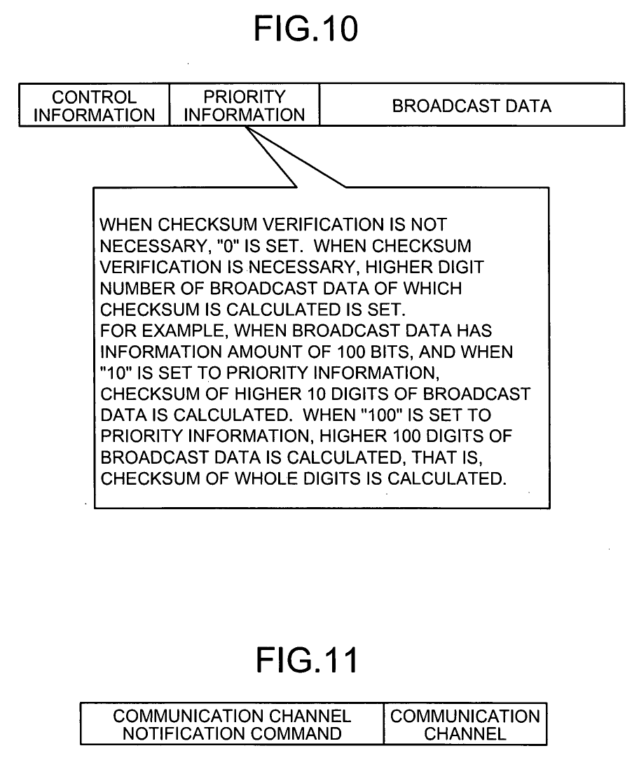

The priority information explained in the second embodiment is not limited to the flag information capable of taking a binary value of “1” or “0”, and can be as follows. FIG. 10 is a table of another example of the communication frame format of broadcast data having priority information according to the second embodiment.

A shown in FIG. 10, a digit number of a high order (or a low order) of the broadcast data of which checksum is to be calculated can be set in the priority information. When the priority information is “0”, it is assumed that broadcast data has predetermined bit information (for example, 100 bits), since the high-order digit number of the broadcast data of which checksum is to be calculated is “0”, the verification of the checksum is not carried out. When the priority information is “10”, the checksum of high-order 10 digits of the broadcast data is calculated and verified. When the priority information is “100”, the checksum of the whole digits of the broadcast data is calculated and verified.

When the digit number of the broadcast data of which checksum is to be calculated is set to the priority information, it is possible to determine a level of accuracy of the verification of the checksum, based on the importance of the information of the broadcast data. Therefore, it is possible to efficiently perform the checksum verification with desired accuracy, without increasing the processing load of the base station 200 and the in-vehicle device 300.

According to the second embodiment, when the in-vehicle device 300 cannot correctly receive the broadcast data transmitted from the base station 200, the broadcast data is transmitted exclusively to the in-vehicle device 300 that cannot correctly receive the broadcast data, based on the importance and priority of the broadcast data. Therefore, the in-vehicle device 300 can securely receive the broadcast data of high priority having relatively high importance, with priority, by efficiently using the transmission path between the base station 200 and the in-vehicle device 300.

The third embodiment is explained with reference to FIGS. 11 to 15. In the third embodiment, a process of differentiating communication channels to be notified to the in-vehicle device 300 based on a verification result of the checksum of the broadcast data is added to the process explained in the first or the second embodiment. The configuration of the road-to-vehicle communication system S, and the configurations of the information providing apparatus 100, the base station 200, and the in-vehicle device 300 respectively in the third embodiment are the same as those explained in the first or the second embodiment, and therefore their explanations will be omitted. Similarly, constituent elements in the third embodiment identical with those of the first and the second embodiments are not explained, and only different points are explained.

An explanation is made about a format of a communication-channel notification command transmitted from the base station A 200a, the base station B 200b, and the base station C 200c to the in-vehicle device 300, in the road-to-vehicle communication system S in the third embodiment. FIG. 11 is a table of an example of the communication-channel notification command format. The communication channel means a frequency used in the radio communications. The communication-channel notification command is a communication frame format to transmit a command to notify a communication channel to the in-vehicle device 300. When the communication channel is notified to the in-vehicle device 300, the base station 200 with which the in-vehicle device 300 communicates next can be allocated and differentiated.

As shown in FIG. 11, the communication-channel notification command format contains the communication-channel notification command and the communication channel. The communication-channel notification command can be stored in the FCMS. In addition, the communication channel can be stored in the MDS.

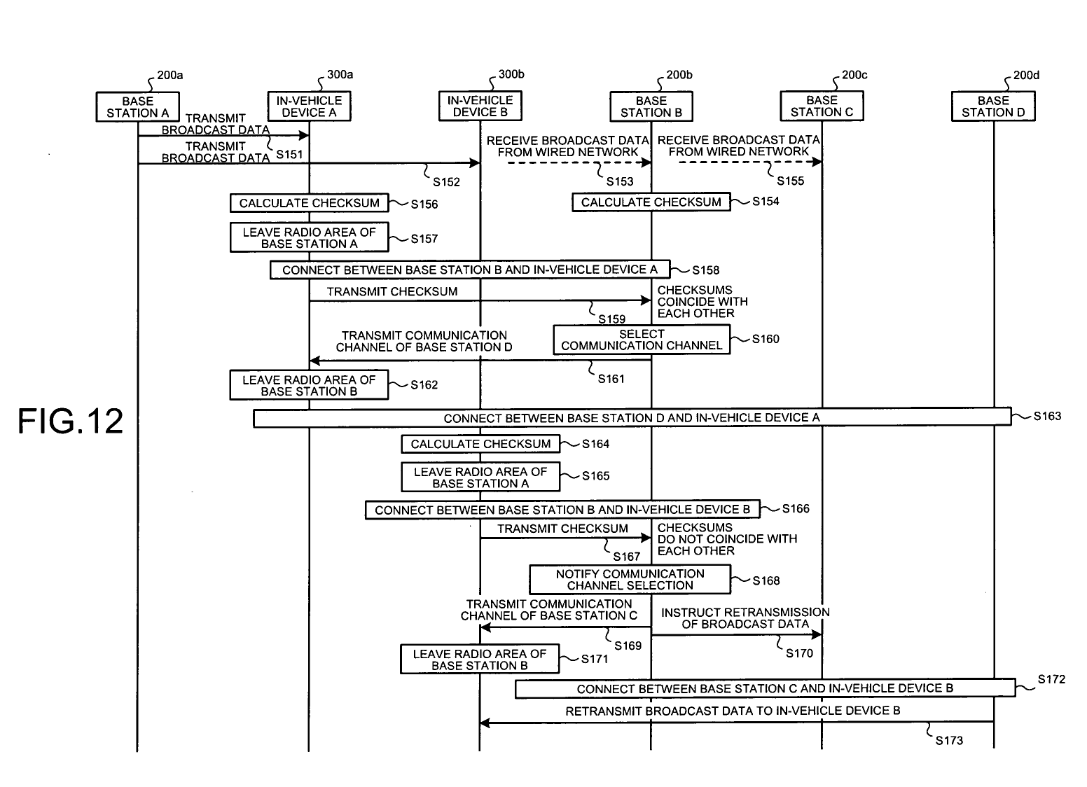

The broadcast data retransmission process executed by the road-to-vehicle communication system S in the third embodiment is explained below. FIG. 12 is a time chart of the broadcast data retransmission process executed by the road-to-vehicle communication system S in the third embodiment. In the process executed in connection with FIG. 12, it is assumed that the information providing apparatus 100 sets in advance the priority information of the broadcast data, and the information providing apparatus 100 transmits the broadcast data to the base station A 200a, the base station B 200b, and the base station C 200c, via the wired network N. It is assumed that two in-vehicle devices of an in-vehicle device A 300a and an in-vehicle device B 300b are in the transmission-data accessible area of the base station A 200a.

As shown in FIG. 12, the base station A 200a transmits broadcast data to the in-vehicle device A 300a (step S151), and transmits the broadcast data to the in-vehicle device B 300b (step S152). The base station B 200b receives the broadcast data via the wired network N (step S153), and calculates in advance a checksum based on the received broadcast data (step S154). The base station C 200c receives the broadcast data (step S155).

The in-vehicle device A 300a calculates a checksum based on the broadcast data received at step S151 from the base station A 200a (step S156). The in-vehicle device A 300a leaves the radio area (a transmission-data accessible area) of the base station A 200a (step S157), and enters the radio area of the base station B 200b. The in-vehicle device A 300a wirelessly connects itself to the base station B 200b (step S158).

The in-vehicle device A 300a transmits a checksum to the base station B 200b (step S159). The base station B 200b receives the checksum, and compares the checksum with the checksum calculated in advance by the base station B 200b, thereby executing a communication-channel selection process (step S160). In this case, it is assumed that both checksums coincide with each other as a result of the comparison, and that the communication channel of a base station D 200d is selected by the communication-channel selection process at step S160. The base station D 200d is irrelevant to the retransmission of the broadcast data.

The base station B 200b transmits a communication channel of the base station D 200d to the in-vehicle device A 300a (step S161). When the in-vehicle device A 300a receives the notification of the communication channel to be used to receive the data from the base station D 200d, the in-vehicle device A 300a does not need to carry out a channel scan of the communication channel (a search process of the communication channel) in the transmission-data accessible area of the base station C 200c, thereby promptly receiving the data.

The in-vehicle device A 300a leaves the radio area (a transmission-data accessible area) of the base station B 200b (step S162), and enters the radio area of the base station D 200d. The in-vehicle device A 300a wirelessly connects itself to the base station D 200d (step S163).

The in-vehicle device B 300b calculates the checksum, based on the broadcast data received at step S152 from the base station A 200a (step S164). The in-vehicle device B 300b leaves the radio area (a transmission-data accessible area) of the base station A 200a (step S165), and enters the radio area of the base station B 200b. The in-vehicle device B 300b wirelessly connects itself to the base station B 200b (step S166).

The in-vehicle device B 300b transmits a checksum to the base station B 200b (step S167). The base station B 200b receives the checksum, and compares the checksum with the checksum calculated in advance by the base station B 200b, thereby executing a communication-channel selection process (step S168). In this case, it is assumed that both checksums do not coincide with each other as a result of the comparison, and that the communication channel of the base station C 200c is selected by the communication-channel selection process at step S168. The base station C 200c serves for retransmitting the broadcast data.

The base station B 200b transmits the communication channel of the base station C 200c to the in-vehicle device B 300b (step S169). When the in-vehicle device 300 receives the notification of the communication channel to be used to receive the retransmission of broadcast data from the base station C 200c, the in-vehicle device B 300b does not need to carry out a channel scan of the communication channel (a search process of the communication channel) in the transmission-data accessible area of the base station C 200c, thereby promptly receiving the broadcast data. The base station B 200b transmits the retransmission instruction of the broadcast data to the base station C 200c (step S170).

The in-vehicle device B 300b leaves the radio area (a transmission-data accessible area) of the base station B 200b (step S171), and enters the radio area of the base station C 200c. The in-vehicle device B 300b wirelessly connects itself to the base station C 200c (step S172). The in-vehicle device B 300b receives the retransmission of the broadcast data from the base station D 200d (step S173).

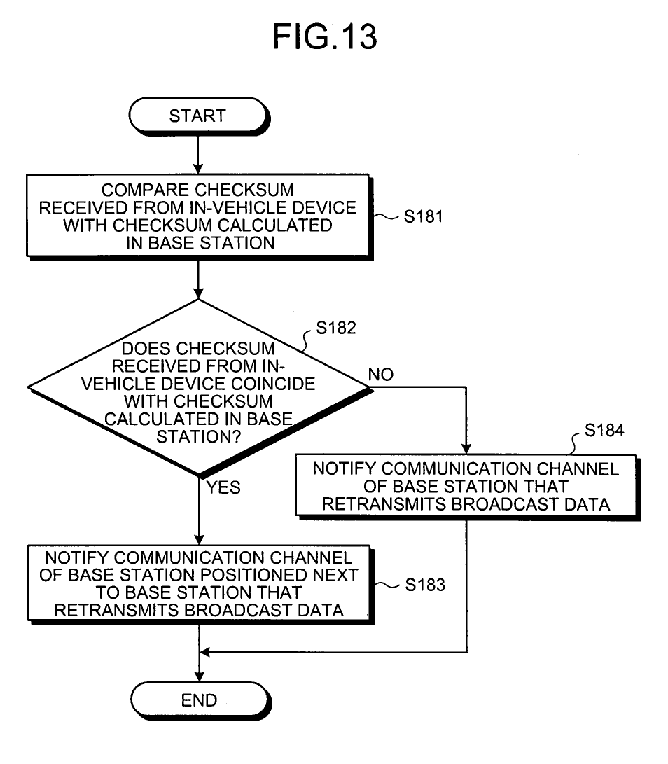

The communication-channel selecting process procedure performed at steps S160 and S168 described in connection with FIG. 12 is explained below. FIG. 13 is a flowchart of the communication-channel selection process performed at steps S160 and S168 described in connection with FIG. 12. As shown in FIG. 13, the checksum comparing unit 205 included in the base station 200 compares the checksum received from the in-vehicle device 300 with the checksum calculated in advance in the base station 200 (step S181). The checksum comparing unit 205 determines whether the checksum received from the in-vehicle device 300 coincides with the checksum calculated in advance in the base station 200 (step S182).

When it is determined that the checksum received from the in-vehicle device 300 coincides with the checksum calculated in advance in the base station 200 (YES at step S182), the checksum comparing unit 205 notifies the communication channel of the base station 200 positioned next to the base station 200 for retransmitting the broadcast data on the path, which is different from the base station 200 for retransmitting the broadcast data, to the in-vehicle device 300 (step S183).

On the other hand, when it is determined that the checksum received from the in-vehicle device 300 does not coincide with the checksum calculated in advance in the base station 200 (NO at step S182), the checksum comparing unit 205 notifies the communication channel of the base station 200 for retransmitting the broadcast data, to the in-vehicle device 300 (step S184).

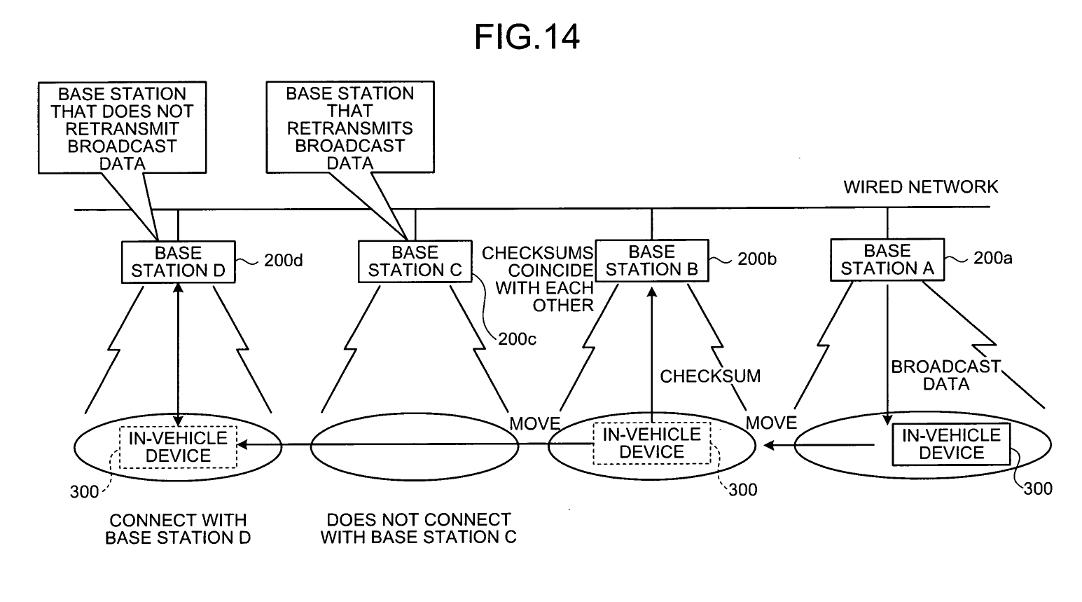

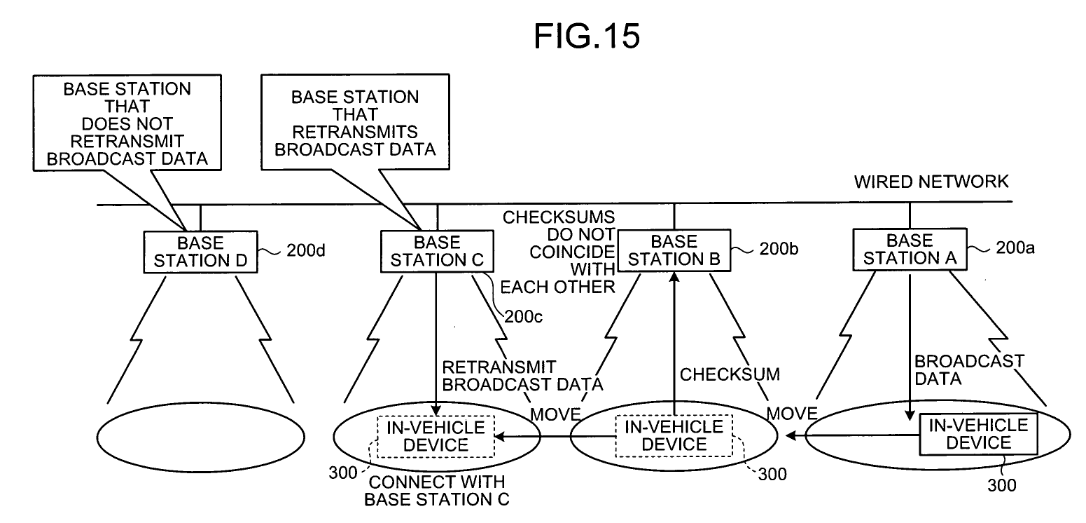

FIG. 14 is a schematic diagram for explaining an operation performed when the checksums coincide with each other in the third embodiment. FIG. 15 is a schematic diagram for explaining an operation performed when the checksums do not coincide with each other in the third embodiment.

In FIG. 14, the in-vehicle device 300 receives the broadcast data from the base station A 200a, leaves the transmission-data accessible area of the base station A 200a, and enters the transmission-data accessible area of the base station B 200b. The in-vehicle device 300 transmits a checksum to the base station B 200b. The base station B 200b determines that the received checksum coincides with the checksum calculated in advance by the base station B 200b. Therefore, the in-vehicle device 300 passes through the transmission-data accessible area of the base station C 200c, and does not carry out the connection to communicate with the base station C 200c as the base station that retransmits the broadcast data. The in-vehicle device 300 enters the transmission-data accessible area of the base station D 200d that is not the base station to retransmit the broadcast data, and establishes a connection to the base station D 200d to communicate with the base station D 200d. The in-vehicle device 300 can perform a communication process to receive other broadcast data, not only establishing the connection to communicate with the base station D 200d.

With reference to FIG. 15, the in-vehicle device 300 receives the broadcast data from the base station A 200a, leaves the transmission-data accessible area of the base station A 200a, and enters the transmission-data accessible area of the base station B 200b. The in-vehicle device 300 transmits a checksum to the base station B 200b. The base station B 200b determines that the received checksum does not coincide with the checksum calculated in advance by the base station B 200b. Therefore, the in-vehicle device 300 enters the transmission-data accessible area of the base station C 200c, and establishes the connection to communicate with the base station C 200c as the base station that retransmits the broadcast data. In this way, when the in-vehicle device 300 fails in receiving the broadcast data from the base station A 200a, the in-vehicle device 300 receives the retransmission of the broadcast data from the base station C 200c, thereby securely receiving the broadcast data.

According to the third embodiment, when the in-vehicle device 300 cannot correctly receive the broadcast data transmitted from the base station 200, the in-vehicle device 300 that could not correctly receive the broadcast data is exclusively connected to the base station that retransmits the broadcast data, and the base station retransmits the broadcast data. When the in-vehicle device 300 can correctly receive the broadcast data transmitted from the base station 200, the in-vehicle device 300 is connected to other base station different from the base station that retransmits the broadcast data. In this way, a base station to be connected to the in-vehicle device 300 next is determined depending on whether the in-vehicle device 300 could correctly receive the broadcast data. Therefore, the in-vehicle device 300 can efficiently and securely receive the broadcast data, by efficiently using the transmission path between the base station 200 and the in-vehicle device 300.

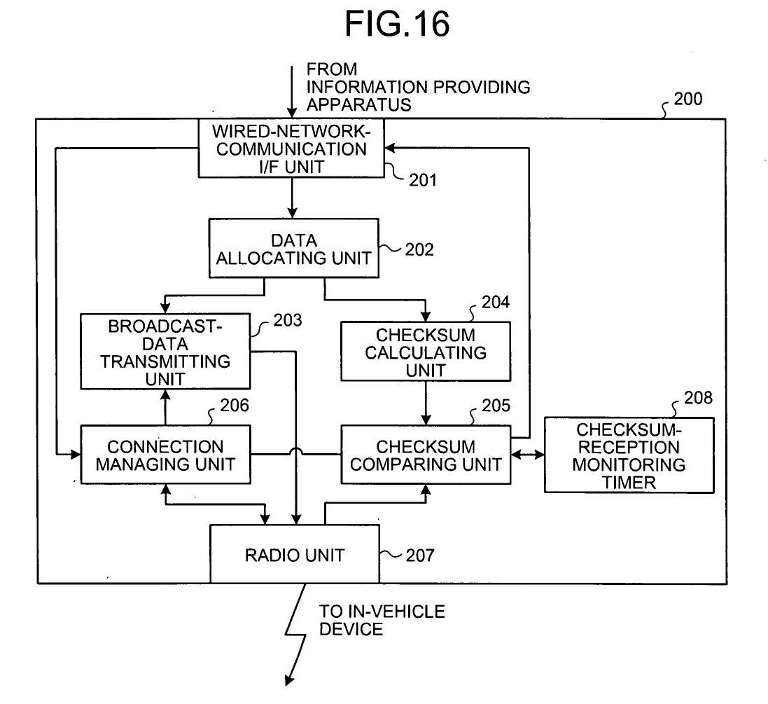

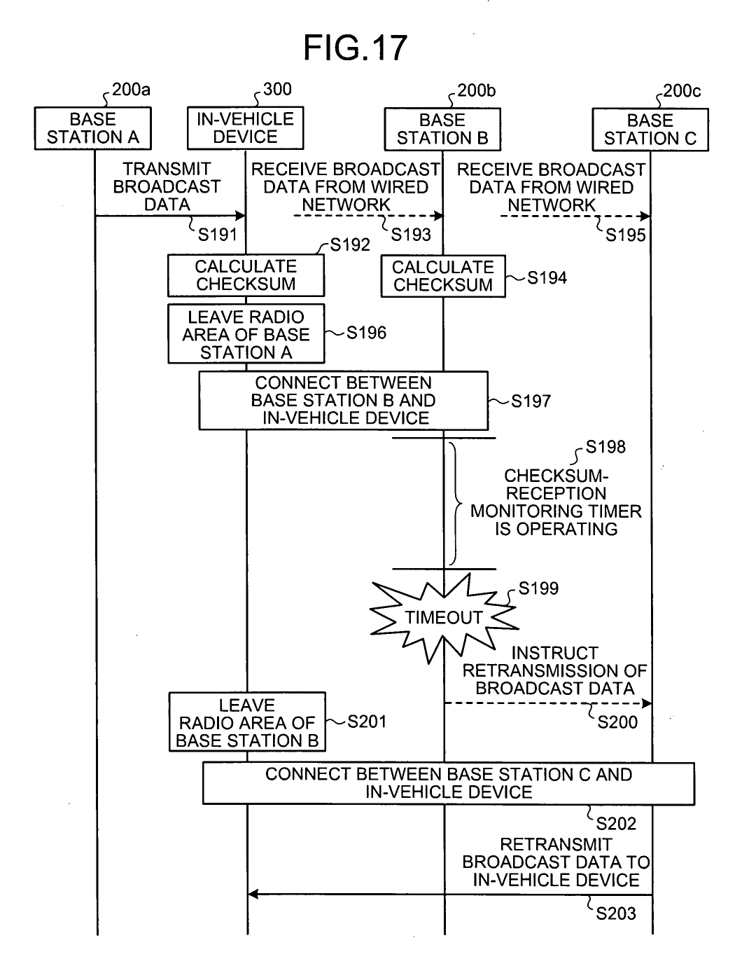

The fourth embodiment is explained below with reference to FIGS. 16 and 17. In the fourth embodiment, a process of retransmitting the broadcast data to the in-vehicle device 300 when the checksum of the broadcast data is not transmitted from the in-vehicle device 300 is added to the process explained in the first, the second, or the third embodiment. The configuration of the road-to-vehicle communication system S, and the configurations of the information providing apparatus 100, the base station 200, and the in-vehicle device 300 respectively in the fourth embodiment are the same as those explained in the first, the second, or the third embodiment, and therefore their explanations will be omitted. Similarly, constituent elements in the fourth embodiment identical with those of the first, the second, or the third embodiments are not explained, and only different points are explained.

FIG. 16 is a functional block diagram of the base station 200 according to the fourth embodiment. The wired-network-communication I/F unit 201, the data allocating unit 202, the broadcast-data transmitting unit 203, the checksum calculating unit 204, the checksum comparing unit 205, the connection managing unit 206, and the radio unit 207 of the base station 200 shown in FIG. 16 have the same configurations and the same functions of those in the first, the second, or the third embodiment, and therefore their explanations will be omitted.

In the fourth embodiment, the base station 200 further includes a checksum-reception monitoring timer 208. The checksum-reception monitoring timer 208 monitors a reception of the checksum from the in-vehicle device 300 that is connected with the base station 200. The checksum-reception monitoring timer 208 counts time after the in-vehicle device 300 is connected to the base station 200, for a predetermined time. When the base station 200 does not receive the checksum from the in-vehicle device 300 after the lapse of the predetermined time, the checksum-reception monitoring timer 208 instructs the wired-network-communication I/F unit 201 via the wired network N to retransmit the broadcast data to the other base station 200 having transmission-data accessible area adjacent to the one of the former base station 200 in the moving direction of the in-vehicle device 300, by specifying the identification information of the in-vehicle device 300 with invalid checksum and the broadcast data with invalid checksum.

FIG. 17 is a time chart of the broadcast data retransmission process executed by the road-to-vehicle communication system S in the fourth embodiment. In the process executed in connection with FIG. 17, it is assumed that the information providing apparatus 100 transmits broadcast data to the base station A 200a, the base station B 200b, and the base station C 200c, via the wired network N. The broadcast data transmitted to the base station A 200a is the data to be transmitted as the broadcast data. The broadcast data transmitted to the base station B 200b is used to calculate in advance the checksum for comparison. The broadcast data transmitted to the base station C 200c is the broadcast data for retransmission.

As shown in FIG. 17, the base station A 200a transmits broadcast data to the in-vehicle device 300 (step S191). The in-vehicle device 300 calculates a checksum based on the broadcast data received from the base station A 200a at step S191 (step S192). The base station B 200b receives the broadcast data via the wired network N (step S193), and calculates in advance the checksum based on the received broadcast data (step S194). The base station C 200c receives the broadcast data (step S195).

The in-vehicle device 300 leaves the radio area (a transmission-data accessible area) of the base station A 200a (step S196), and enters the radio area of the base station B 200b. The in-vehicle device 300 wirelessly connects itself to the base station B 200b (step S197).

The checksum-reception monitoring timer 208 of the base station B 200b monitors the checksum reception for a predetermined time (step S198). When the checksum is not received even after the predetermined time elapsed, the monitoring of the checksum reception times out (step S199).

When the timeout at step S199 occurs, the base station B 200b instructs the base station C 200c to retransmit the broadcast data (step S200). In this case, the base station B 200b can notify the communication channel to be used to receive the retransmission of the broadcast data from the base station C 200c, to the in-vehicle device 300. When the in-vehicle device 300 receives the notification of the communication channel to be used to receive the retransmission of the broadcast data from the base station C 200c, the in-vehicle device 300 does not need to carry out a channel scan of the communication channel (a search process of the communication channel) in the transmission-data accessible area of the base station C 200c, thereby promptly receiving the retransmission of the broadcast data.

The in-vehicle device 300 leaves the radio area (a transmission-data accessible area) of the base station B 200b (step S201), and enters the radio area of the base station C 200c. The in-vehicle device 300 wirelessly connects itself to the base station C 200c (step S202). The base station C 200c retransmits the broadcast data to the in-vehicle device 300 (step S203).

According to the fourth embodiment, when the in-vehicle device 300 in the transmission-data accessible area of the broadcast data does not receive the broadcast data, the broadcast data can be retransmitted to the in-vehicle device 300, thereby securely transmitting the broadcast data. Even when the in-vehicle device 300 receives the broadcast data, a certain problem can occur in a process of generating the checksum in the in-vehicle device 300 or a process of transmitting the verification data to the base station 200. Even when this problem occurs, the broadcast data can be retransmitted, thereby transmitting the broadcast data more securely.

In the first to the fourth embodiments, while checksums are explained as verification data based on the broadcast data, the verification data is not limited to the checksum and can be any other data that can verify the correctness of the broadcast data. Particularly, in the above embodiments, no check data is added to the broadcast data transmitted from the base station 200 to the in-vehicle device 300, so that it is possible to efficiently allocate communication slots to the broadcast data and to avoid a reduction in the transmission efficiency of the broadcast data. As explained above, if the in-vehicle device 300 can generate verification data based on the received broadcast data, without adding check data to the broadcast data transmitted from the base station 200 to the in-vehicle device 300, verification data of any system can be employed.

Furthermore, execution of a one-stage retransmission process is explained assuming that the processes from the broadcast data reception to the transmission of the verification data, determination of validity of the verification data, and retransmission of the broadcast data is performed as one transmission process. However, the retransmission process can be repeated at two stages or more, thereby enabling the in-vehicle device 300 to receive the broadcast data more securely.

Among the respective process explained in the first to the fourth embodiments, all or a part of the processes explained as being performed automatically can be performed manually, or all or a part of the processes explained as being performed manually can be performed automatically in a known method. In addition, information including the process procedures, control procedures, specific names, and various kinds of data and parameters shown in the first to the fourth embodiments can be optionally changed unless otherwise specified.

The respective constituent elements of the devices shown in the drawings are functionally conceptual, and physically the same configuration is not always necessary. In other words, the specific mode of distribution and integration of the devices is not limited to the shown ones, and all or a part thereof can be functionally or physically distributed or integrated in an optional unit, according to various kinds of load and the status of use.

Furthermore, all or an optional part of various process functions performed by the respective devices can be realized by a central processing unit (CPU) (or micro computers such as a micro processing unit (MPU) and a micro controller unit (MCU)) or a program analyzed and executed by the CPU, or can be realized as hardware by the wired logic.

According to an aspect of the present invention, broadcast data transmission and broadcast data retransmission can be carried out in different communications. Data transmission efficiency of the broadcast data transmission can be maintained. The broadcast data can be securely retransmitted exclusively to the data receiving apparatus that has a reception error of the broadcast data. Verification data that becomes the basis of determining the reception error of the broadcast data is generated based on the broadcast data itself. Information to carry out an error check does not need to be added to the broadcast data, and transmission efficiency of the broadcast data can be increased.

According to another aspect of the present invention, whether the validity of the broadcast data is to be determined based on the importance of transmission data, and desired accuracy of the determination of validity of the broadcast data can be set, thereby efficiently determining the validity of the broadcast data.

According to still another aspect of the present invention, the data receiving apparatus does not need to search a communication channel. The data receiving apparatus is allocated to either a third data transmitting apparatus or a fourth data transmitting apparatus based on the need to retransmit the broadcast data. Therefore, efficient data communication can be carried out.

According to still another aspect of the present invention, when the data receiving apparatus cannot receive the broadcast data from the beginning at all, the broadcast data can be retransmitted as appropriate.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method of transmitting broadcast data from a plurality of transmitting apparatus to a data receiving apparatus, each of the transmitting apparatuses having a transmission area in which broadcast data is transmitted from a corresponding one of the transmitting apparatuses, the transmitting apparatuses sharing the broadcast data, the receiving apparatus freely moving from one transmission area to another transmission area, the transmitting apparatuses including a first transmitting apparatus, a second transmitting apparatus, and a third transmitting apparatus, the method comprising:
generating first verification data in the receiving apparatus based on the broadcast data received from the first transmitting apparatus;
generating second verification data in the second transmitting apparatus based on the broadcast data;
transmitting the first verification data from the receiving apparatus to the second transmitting apparatus when the receiving apparatus moves in a transmission area of the second transmitting apparatus;
determining at the second transmitting apparatus whether the first verification data is valid based on the second verification data;
transmitting a retransmission instruction of the broadcast data from the second transmitting apparatus to the third transmitting apparatus when the first verification data is determined as not valid; and
retransmitting the broadcast data based on the retransmission instruction from the third transmitting apparatus to the receiving apparatus.

2. The method according to claim 1, further comprising transmitting priority information, along with the broadcast data, indicative of whether determination of validity of verification data is to be performed, wherein the generating the first verification data includes generating the first verification data when the priority information indicates that the determination of validity of verification data is to be performed.

3. The method according to claim 1, further comprising:
determining, in the second transmitting apparatus, a communication channel for retransmitting the broadcast data to the receiving apparatus; and
notifying the communication channel determined at the determining to the receiving apparatus, wherein the receiving apparatus receives the broadcast data via the communication channel determined at the determining.

4. The method according to claim 1, further comprising detecting, in the second transmitting apparatus, whether the first verification data is received, wherein the transmitting the retransmission instruction includes transmitting a retransmission instruction of the broadcast data from the second transmitting apparatus to the third transmitting apparatus when it is detected at the detecting that the first verification data is not received.

5. A receiving apparatus that receives broadcast data transmitted from a plurality of transmitting apparatuses in each transmission area of the transmitting apparatuses, the transmitting apparatuses including a first transmitting apparatus, a second transmitting apparatus, and a third transmitting apparatus, the receiving apparatus freely moving from one transmission area to another transmission area, the receiving apparatus comprising:
a generating unit that generates verification data based on the broadcast data received from the first transmitting apparatus; and
a transmitting unit that transmits the verification data to the second transmitting apparatus when the receiving apparatus moves in a transmission area of the second transmitting apparatus.

6. The receiving apparatus according to claim 5, further comprising a receiving unit that receives priority information, along with the broadcast data, indicative of whether determination of validity of verification data is to be performed, wherein
the generating unit generates the verification data when the priority information indicates that the determination of validity of verification data is to be performed.

7. A transmitting apparatus that transmits broadcast data to a receiving apparatus, and receives verification data generated based on the broadcast data from the receiving apparatus when the receiving apparatus is in a transmission area of the transmitting apparatus, the transmitting apparatus comprising:
a determining unit that determines whether the verification data received from the receiving apparatus is valid;
a transmitting unit that transmits a retransmission instruction of the broadcast data, to another transmitting apparatus when the determining unit determines that the verification data is not valid;
a receiving unit that receives a retransmission instruction from another transmitting apparatus; and
a retransmitting unit that retransmits the broadcast data to the receiving apparatus upon the receiving unit receiving the retransmission instruction.

8. The transmitting apparatus according to claim 7, further comprising:
a determining unit that determines a communication channel for retransmitting the broadcast data to the receiving apparatus; and
a notifying unit that notifies the communication channel determined by the determining unit to the receiving apparatus, wherein the retransmitting unit retransmits the broadcast data to the receiving apparatus via the communication channel determined by the determining unit.

9. The transmitting apparatus according to claim 7, further comprising a detecting unit that detects whether the verification data is received, wherein the retransmission-instruction transmitting unit transmits a retransmission instruction of the broadcast data to the other transmitting apparatus when it is detected by the detecting unit that the verification data is not received.

10. A data transmission system in which a plurality of transmitting apparatuses transmit broadcast data to a receiving apparatus in each transmission area of the transmitting apparatuses, the transmitting apparatuses including a first transmitting apparatus, a second transmitting apparatus, and a third transmitting apparatus, and the receiving apparatus freely moving from one transmission area to another transmission area, wherein
the receiving apparatus includes
a generating unit that generates verification data based on the broadcast data received from the first transmitting apparatus; and
a transmitting unit that transmits the verification data to the second transmitting apparatus when the receiving apparatus moves in a transmission area of the second transmitting apparatus, and
the transmitting apparatus includes
a determining unit that determines whether the verification data received from the receiving apparatus is valid;
a transmitting unit that transmits a retransmission instruction of the broadcast data, to another transmitting apparatus when the determining unit determines that the verification data is not valid;
a receiving unit that receives a retransmission instruction from another transmitting apparatus; and
a retransmitting unit that retransmits the broadcast data to the receiving apparatus upon the receiving unit receiving the retransmission instruction.
